(19) United States
(12) Patent Application Publication
(10) Pub. No.: US 2015/0309204 A1
(43) Pub. Date: Oct. 29, 2015

(54) MAGNETIC SENSOR DEVICE

(71) Applicant: NIDEC SANKYO CORPORATION, Suwa-gun, Nagano (JP)

(72) Inventors: Shogo MOMOSE, Suwa-gun, Nagano (JP); Tetsuo MOCHIDA, Suwa-gun, Nagano (JP)

(21) Appl. No.: 14/648,138

(22) PCT Filed: Nov. 11, 2013
(86) PCT No.: PCT/JP2013/080490

§ 371 Date: May 28, 2015

(30) Foreign Application Priority Data
Nov. 28, 2012 (JP) 2012-260299

(51) Int. Cl. G01V 3/10; G01V 3/38

(52) U.S. Cl. CPC G01V 3/104; G01V 3/38

(57) ABSTRACT

A magnetic sensor device may include an exciting coil; a detection coil which faces the exciting coil and is structured to detect an AC magnetic field generated by the exciting coil; an object arrangement space which is provided between the detection coil and the exciting coil; and a case member which covers an entire surrounding area for the detection coil and the exciting coil except a side facing the exciting coil in a surrounding area for the detection coil and except a side facing the detection coil in a surrounding area for the exciting coil. The case member may be made of nonmagnetic conductive metal.

### CROSS REFERENCE TO RELATED APPLICATIONS

This is the U.S. national stage of application No. PCT/JP2013/080490, filed on Nov. 11, 2013. Priority under 35 U.S.C. §119(a) and 35 U.S.C. §365(B) is claimed from Japanese Application No. 2012-260299, filed Nov. 28, 2012, the disclosures of which are incorporated herein by reference.

### TECHNICAL FIELD

The present invention relates to a magnetic sensor device structured to magnetically detect metal material mixed with an inspection object or metal material applied to an inspection object.

### BACKGROUND

As a device for magnetically detecting a metal foreign matter contained in an inspection object, a device (see Patent Literature 1) has been proposed which includes a conveying passage through which inspection objects are successively conveyed, a magnetization unit disposed along the conveying passage, and two magnetic sensors disposed on a downstream side with respect to the magnetization unit and, based on a difference between output signals of the two magnetic sensors, a metal foreign matter is detected. In the device described in Patent Literature 1, a metal foreign matter is magnetized in advance by the magnetization unit to enable detection of a relatively minute metal foreign matter. Further, influence of a disturbance magnetic field such as peripheral equipment noise is restricted by calculating a difference between output signals of the two magnetic sensors.

### PATENT LITERATURE

[PTL 1] Japanese Patent Laid-Open No. 2009-257989

In a magnetic sensor in which a magnetic field is generated by an exciting coil and the magnetic field is detected by a detection coil, the magnetic field generated by the magnetic sensor itself (magnetic field by the exciting coil and the detection coil) is extended to the outside of the sensor. When an electric conductor other than an inspection object is existed within a magnetic field extended to the outside of the sensor and it performs some motion such as vibration, a variation of the magnetic field by the electric conductor may be detected to cause an erroneous detection. In the device described in Patent Literature 1, although influence of a disturbance magnetic field can be eliminated, an erroneous detection of an electric conductor existed in the outside of the sensor cannot be prevented due to the magnetic field of the magnetic sensor itself.

### SUMMARY

In view of the problem described above, at least an embodiment of the present invention provides a magnetic sensor device which is capable of preventing an erroneous detection due to influence of an electric conductor existed in the outside of the sensor caused by a magnetic field generated by the magnetic sensor itself.

To achieve the above, at least an embodiment of the present invention provides a magnetic sensor device including an exciting coil, a detection coil which faces the exciting coil and detects an AC magnetic field generated by the exciting coil, an object arrangement space which is provided between the detection coil and the exciting coil, and a case member which covers an entire surrounding area for the detection coil and the exciting coil except a side facing the exciting coil in a surrounding area for the detection coil and except a side facing the detection coil in a surrounding area for the exciting coil. The case member is made of nonmagnetic conductive metal.

In at least an embodiment of the present invention, as described above, the detection coil and the exciting coil are faced each other with the object arrangement space interposed therebetween and the case member (nonmagnetic conductive metal) is disposed so as to cover the entire surrounding space for coils except the sides that the respective coils face toward the object arrangement space. According to this structure, an eddy current is generated in the case member (nonmagnetic conductive metal) by a magnetic field extended from the detection coil and the exciting coil to the outside, and a magnetic field opposite to the magnetic field caused by the detection coil and the exciting coil is generated. As a result, the original magnetic field is canceled and thus extension of the magnetic field by the detection coil and the exciting coil to the outside can be prevented without affecting the magnetic field in the object arrangement space. Therefore, erroneous detection caused by an electric conductor located on the outside of the object arrangement space (electric conductor except an inspection object) can be prevented.

In at least an embodiment of the present invention, it is desirable that the magnetic sensor device includes a magnetic shield part comprised of a magnetic member which is disposed on one of an inner side and an outer side of the case member, or both of the inner side and the outer side of the case member. Since a magnetic member is easy to make the magnetism pass, when a disturbance magnetic field is present, the disturbance magnetic field passes through the magnetic member structuring the magnetic shield part. Therefore, the inside space covered by the magnetic shield part can be prevented from being affected by the disturbance magnetic field. Accordingly, erroneous detection due to a disturbance magnetic field can be prevented. Further, the magnetic shield part effectively functions as an electromagnetic noise countermeasure component (EMC) which is capable of preventing erroneous detection and erroneous operation due to electromagnetic noise from the outside.

In this case, a housing in a rectangular parallelepiped shape may be used as the case member, which includes a first side face which is disposed on a side opposite to the detection coil with respect to the exciting coil, a second side face which is disposed on a side opposite to the exciting coil with respect to the detection coil, a third side face which connects one side edge of the first side face with one side edge of the second side face, a fourth side face which connects the other side edge of the first side face with the other side edge of the second side face, an upper face which closes an upper end opening of a case side face part comprised of the first side face, the second side face, the third side face and the fourth side face and covers an upper side of the detection coil and the exciting coil, and a bottom face which closes a lower end opening of the case side face part and covers a lower side of the detection coil and the exciting coil. The upper face and the bottom face are provided with openings formed in regions corresponding to the object arrangement space. According to this structure, the entire surrounding space for the coils can be covered except the sides directing from the detection coil and the exciting coil toward the object arrangement space.

In at least an embodiment of the present invention, it is preferable that the magnetic shield part includes a side face part shield member which is stuck on respective inner side faces of the first side face, the second side face, the third side face and the fourth side face, a bottom face shield member which is stuck on an inner side face of the bottom face, and a cover part shield member which is stuck on an inner side face of the upper face, and that the bottom face shield member and the cover part shield member are provided with openings formed in regions corresponding to the object arrangement space. Since a magnetic member is easy to make the magnetism pass, when a disturbance magnetic field is present, the disturbance magnetic field passes through the magnetic member structuring the magnetic shield part. Therefore, the inside space covered by the magnetic shield part can be prevented from being affected by the disturbance magnetic field. Accordingly, erroneous detection due to a disturbance magnetic field can be prevented. Further, the magnetic shield part effectively functions as an electromagnetic noise countermeasure component (EMC) which is capable of preventing erroneous detection and erroneous operation due to electromagnetic noise from the outside.

Further, in at least an embodiment of the present invention, it is desirable that the magnetic sensor device includes a magnetic flux passage part which is disposed at a position deviated from a region where the exciting coil and the detection coil are faced each other in a direction perpendicular to a direction that the exciting coil and the detection coil are faced each other, and the magnetic flux passage part is made of nonmagnetic conductive metal. According to this structure, leakage flux directing from the exciting coil and the detection coil toward the outside of the object arrangement space is guided so as to pass through the magnetic flux passage part. Therefore, leakage of magnetic flux passing through the object arrangement space to the outside can be reduced.

In at least an embodiment of the present invention, it is preferable that the magnetic flux passage part is disposed on both of one side in a widthwise direction of the object arrangement space and the other side in the widthwise direction of the object arrangement space. Further, in at least an embodiment of the present invention, it is preferable that the magnetic flux passage part is attached to the bottom face of the case member and is formed so as to protrude toward the upper face of the case member from the bottom face. According to this structure, leakage flux directing from the exciting coil and the detection coil toward the outside of the object arrangement space is guided so as to pass through the magnetic flux passage part. Therefore, leakage of magnetic flux passing through the object arrangement space to the outside can be reduced.

In this case, it is desirable that the magnetic sensor device includes an exciting coil core to which the exciting coil is attached, a detection coil core to which the detection coil is attached, and a resin sealing part which seals a magnetic sensor element structured so that the exciting coil is attached to the exciting coil core and the detection coil is attached to the detection coil core, and that the resin sealing part structures a resin block body in which the magnetic sensor element is sealed, and the resin block body is attached to the case member through the magnetic flux passage part. When the coils and the core body are sealed with resin as described above, trouble due to humidity, vibration or the like can be reduced and reliability and durability of the magnetic sensor device can be improved. Further, the magnetic flux passage part is also used as an attaching member for fixing the magnetic sensor element and thus the number of structural members can be reduced.

Further, it is desirable that the exciting coil core and the detection coil core are magnetically coupled to each other. According to this structure, leakage flux can be reduced and sensitivity can be enhanced.

In at least an embodiment of the present invention, it is desirable that the exciting coil core and the detection coil core are provided in a core body formed in a frame shape which surrounds the object arrangement space, the core body is formed in a plate shape, and a distance between the core body and a portion of the case member disposed on a front face side of the core body and a distance between the core body and a portion of the case member disposed on a rear face side of the core body are equal to each other. According to this structure, magnetic fields on the front side and the rear side with respect to the core body can be made to be symmetric and thus sensitivity for an inspection object passing through the object arrangement space can be enhanced.

In at least an embodiment of the present invention, it is preferable that the exciting coil is provided around an exciting coil core disposed on one side with respect to the object arrangement space, the detection coil is provided around a detection coil core disposed on the other side with respect to the object arrangement space, and the exciting coil core and the detection coil core are magnetically coupled to each other. According to this structure, leakage flux can be reduced and thus high sensitivity can be obtained.

In at least an embodiment of the present invention, it is preferable that a plurality of the detection coil cores is disposed on the other side with respect to the object arrangement space, and the detection coil is provided around each of a plurality of the detection coil cores. In addition, in at least an embodiment of the present invention, it is preferable that one piece of the exciting coil core is disposed on one side with respect to the object arrangement space.

In at least an embodiment of the present invention, it is preferable that the exciting coil core is a salient pole-shaped core which is protruded from one side with respect to the object arrangement space toward the other side with respect to the object arrangement space, and the detection coil core is a salient pole-shaped core which is protruded from the other side with respect to the object arrangement space toward the one side with respect to the object arrangement space. According to this structure, the exciting coil and the detection coil are wound around salient pole-shaped cores and thus leakage flux can be reduced. Accordingly, high sensitivity can be obtained and, since leakage flux is hard to affect adjacent detection coils and thus the resolution is high.

In at least an embodiment of the present invention, it is desirable that the magnetic sensor device includes a conveying mechanism which conveys an inspection object to the object arrangement space. According to this structure, an inspection object can be conveyed automatically.

According to at least an embodiment of the present invention, an eddy current is generated in the case member (nonmagnetic conductive metal) by a magnetic field extended from the detection coil and the exciting coil to the outside, and a magnetic field opposite to the magnetic field caused by the detection coil and the exciting coil is generated. As a result, the original magnetic field is canceled and thus extension of the magnetic field by the detection coil and the exciting coil to the outside can be prevented without affecting the magnetic field in the object arrangement space. Therefore, erroneous detection caused by an electric conductor (electric conductor other than an inspection object) located on the outside of the object arrangement space can be prevented.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is an explanatory view showing an inspection apparatus including a magnetic sensor device in accordance with an embodiment of the present invention.

FIGS. 2A and 2B are explanatory views (front view and cross-sectional view) schematically showing a magnetic sensor device.

FIG. 3 is an exploded perspective view schematically showing a magnetic sensor device.

FIGS. 4A, 4B and 4C are explanatory views showing a magnetic sensor element.

FIGS. 5A and 5B are explanatory views showing a measurement principle in a magnetic sensor element.

FIG. 6 is an exploded perspective view showing a sensor case.

### DESCRIPTION OF EMBODIMENTS

An embodiment to which the present invention is applied will be described below with reference to the accompanying drawings. In the following description, a direction in which an exciting coil and a detection coil face each other is set in a “Z”-axis direction, a direction perpendicular to the “Z”-axis direction is set in an “X”-axis direction, and a direction perpendicular to the “X”-axis direction and the “Z”-axis direction is set in a “Y”-axis direction. Further, the “Z”-axis direction corresponds to a thickness direction of an inspection object, the “X”-axis direction corresponds to a widthwise direction of the inspection object, and the “Y”-axis direction corresponds to a conveying direction of the inspection object.

### (Entire Structure of Inspection Apparatus)

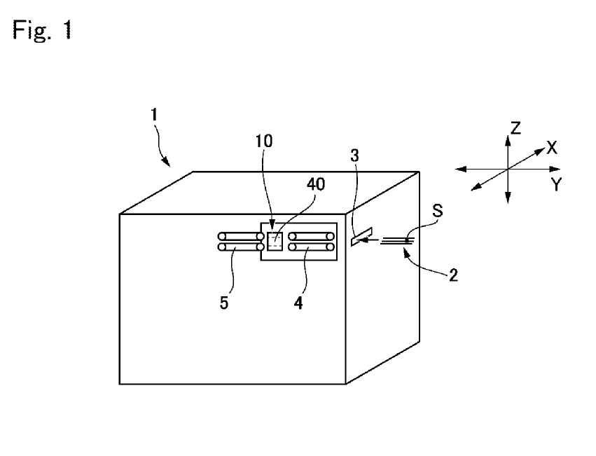

FIG. 1 is an explanatory view showing an inspection apparatus including a magnetic sensor device in accordance with an embodiment of the present invention. In FIG. 1, in an ATM apparatus 1 (Automatic Teller Machine) installed in a bank or the like, a magnetic sensor device 10 is mounted which magnetically inspects whether or not a metal foreign matter “S” such as a clip or a staple of a stapler is mixed with one or plural bank bills 2 (inspection object) having been inputted. The magnetic sensor device 10 includes a belt type conveying mechanism 4 for conveying a bank bill 2 in the “Y”-axis direction from an input port 3 to an object arrangement space 40 of the magnetic sensor device 10, and a belt type conveying mechanism 5 for conveying the bank bill 2 in the “Y”-axis direction from the object arrangement space 40 of the magnetic sensor device 10 to a bank bill identifying machine (not shown).

### (Magnetic Sensor Device)

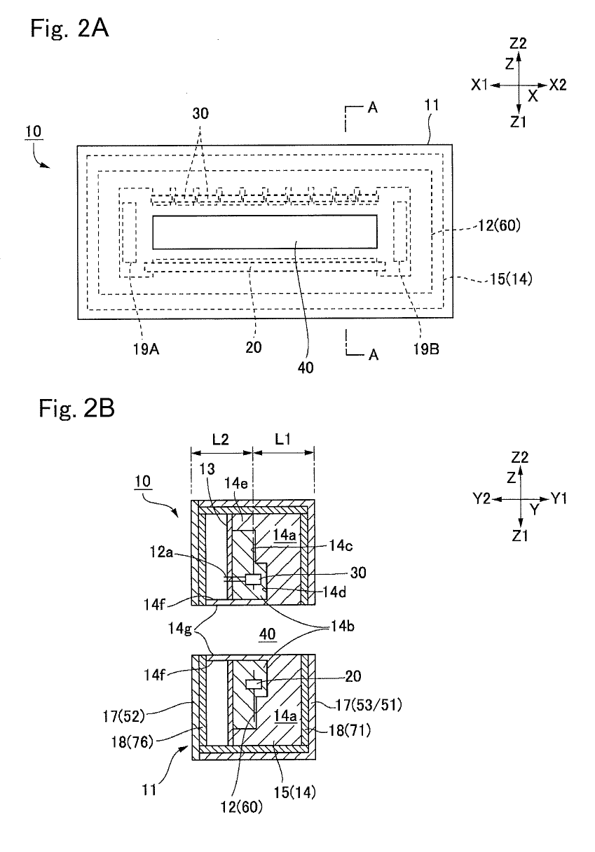

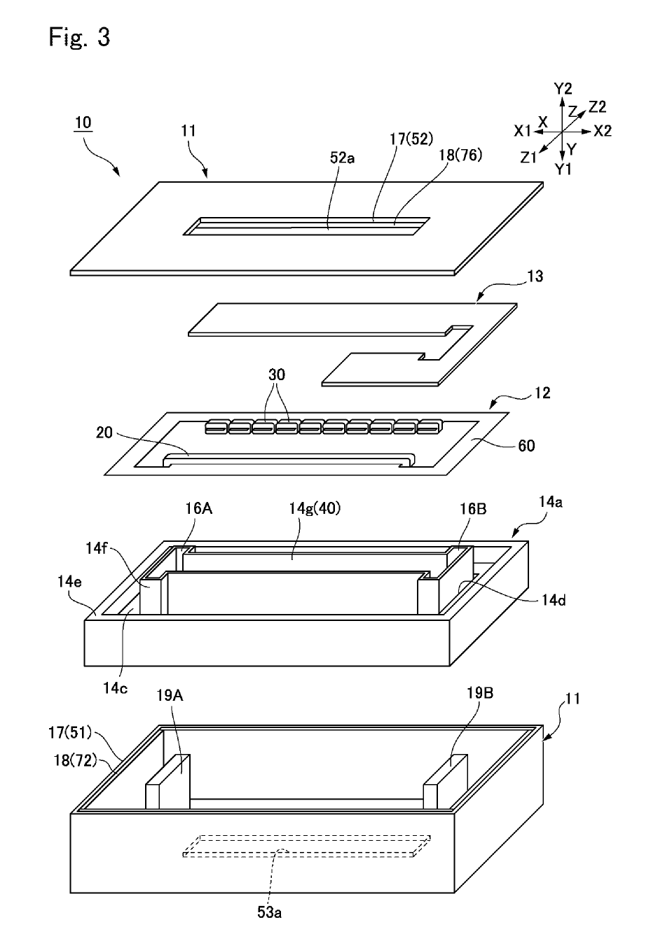

FIGS. 2A and 2B are explanatory views schematically showing the magnetic sensor device 10. FIG. 2A is a front view showing the magnetic sensor device and FIG. 2B is the “A-A” cross-sectional view in FIG. 2A. FIG. 3 is an exploded perspective view schematically showing the magnetic sensor device. As shown in FIGS. 2A and 2B and FIG. 3, the magnetic sensor device 10 includes a sensor case 11 formed in a substantially rectangular parallelepiped shape, a magnetic sensor element 12 which is structured in an inside of the sensor case 11, a circuit board 13 which is disposed in an inside of the sensor case 11 and is electrically connected with the magnetic sensor element 12, and a resin sealing part 14 which seals the magnetic sensor element 12. The resin sealing part 14 is structured of a resin frame 14a which is molded in advance and is disposed in an inside of the sensor case 11, and a resin filled part 14b which is filled so as to cover the magnetic sensor element 12 disposed on the resin frame 14a. In FIG. 2A, the circuit board 13 is not shown. Further, in FIG. 3, the resin filled part 14b is not shown. In the inside of the sensor case 11, a resin block body 15 in which the magnetic sensor element 12 is sealed is structured of the resin sealing part 14 (resin frame 14a and resin filled part 14b).

An upper face of the resin frame 14a is formed with a rectangular recessed part 14c which corresponds to an outward form of the magnetic sensor element 12. An inner periphery part of a bottom face of the recessed part 14c is formed with an inner side recessed part 14d which is recessed by one step with respect to the bottom face of the recessed part 14c. An outside frame part 14e is provided on an outer peripheral side of the recessed part 14c and an inner side frame part 14f is provided on an inner peripheral side of the inner side recessed part 14d. A penetration part 14g which penetrates through the resin frame 14a in the “Y”-axis direction is provided on an inner side of the inner side frame part 14f. The penetration part 14g is formed in an oblong shape which is long in the “X”-axis direction. The resin filled part 14b is filled in the recessed part 14c and the inner side recessed part 14d and portions of terminal pins 12a of the magnetic sensor element 12 except their tip ends are entirely covered. The circuit board 13 is disposed on a surface of the resin filled part 14b and the circuit board 13 is connected with the terminal pins 12a which are protruded from the resin filled part 14b.

A center region in the “X”-axis direction of the penetration part 14g of the resin frame 14a is structured so as to determine an object arrangement space 40 when disposed in the inside of the sensor case 11. On the other hand, a first attaching part 16A whose width in the “Z”-axis direction is wider than the object arrangement space 40 is provided on one end side “X1” in the “X”-axis direction of the penetration part 14g. Further, a second attaching part 16B whose width in the “Z”-axis direction is wider than the object arrangement space 40 is provided on the other end side “X2” in the “X”-axis direction of the penetration part 14g. The first and the second attaching parts 16A and 16B are provided at positions separated in the “X”-axis direction from a region where an exciting coil 20 and detection coils 30 are faced each other. The resin block body 15 is, as described below, attached to magnetic flux passage parts 19A and 19B provided in the sensor case 11 through the first and the second attaching parts 16A and 16B.

### (Magnetic Sensor Element)

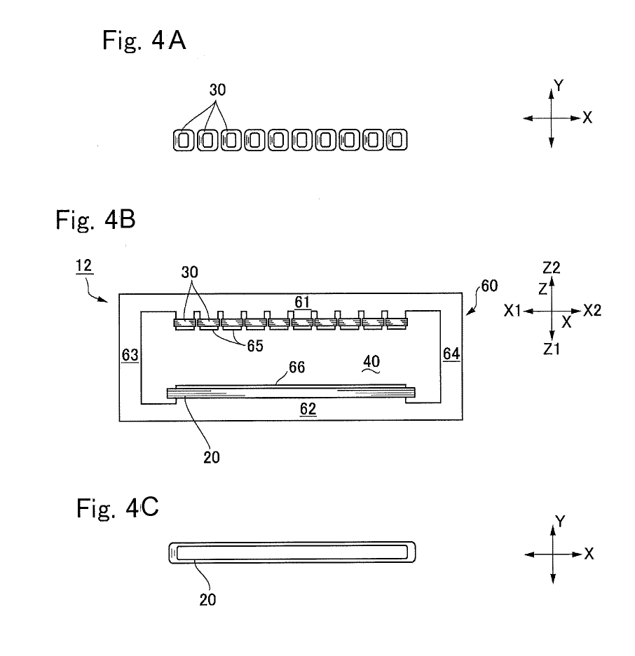

FIGS. 4A, 4B and 4C are explanatory views showing the magnetic sensor element 12. FIG. 4A is a front view showing the magnetic sensor element 12, FIG. 4B is a plan view showing detection coils which are viewed in the “Z”-axis direction, and FIG. 4C is a plan view showing an exciting coil viewed in the “Z”-axis direction. As shown in FIGS. 2A through 4C, the magnetic sensor element 12 includes an exciting coil 20 which is disposed on one side “Z1” in the “Z”-axis direction with respect to the object arrangement space 40, a plurality of detection coils 30 which are disposed on the other side “Z2” in the “Z”-axis direction with respect to the object arrangement space 40, and a core body 60 to which the exciting coil 20 and the detection coils 30 are wound. A plurality of the detection coils 30 faces the exciting coil 20 in the “Z”-axis direction.

The core body 60 is a plate-shaped magnetic body whose thickness direction is the “Y”-axis direction. As shown in FIG. 4A, the core body 60 is formed in a rectangular frame shape which is provided with a frame part 61 extended in the “X”-axis direction on the other side “Z2” in the “Z”-axis direction with respect to the object arrangement space 40, a frame part 62 extended in the “X”-axis direction on one side “Z1” in the “Z”-axis direction with respect to the object arrangement space 40, a frame part 63 connecting end parts on one side “X1” in the “X”-axis direction of the frame parts 61 and 62 with each other, and a frame part 64 connecting end parts on the other side “X2” in the “X”-axis direction of the frame parts 61 and 62 with each other. An outward form of the core body 60 is a rectangle in which the frame parts 61 and 62 are its long sides and the frame parts 63 and 64 are its short sides.

In this embodiment, an edge of the frame part 61 facing the frame part 62 is formed with a plurality of detection coil cores 65 in a salient pole shape protruded toward the frame part 62 at a constant pitch in the “X”-axis direction. On the other hand, an edge of the frame part 62 facing the frame part 61 is formed with one exciting coil core 66 in a salient pole shape protruded toward the frame part 61. The exciting coil 20 is wound around the exciting coil core 66. Further, the detection coil 30 is wound around each of a plurality of the detection coil cores 65. A plurality of the detection coils 30 is linearly arranged in the “X”-axis direction and is disposed on an opposite side (the other side “Z2” in the “Z”-axis direction) to the exciting coil 20 with the object arrangement space 40 interposed therebetween. The exciting coil 20 is driven by a drive circuit (not shown) to generate an AC magnetic field and the detection coils 30 detect the AC magnetic field which is generated by the exciting coil 20.

As described above, the exciting coil core 66 and the detection coil core 65 are formed in one core body 60 and are magnetically coupled to each other and thus leakage flux can be reduced. Therefore, high sensitivity can be obtained and leakage flux is hard to affect adjacent detection coils 30 and thus the resolution is high. In accordance with an embodiment of the present invention, it may be structured that a magnetic body structuring the exciting coil core 66 and a magnetic body structuring the detection coil cores 65 are closely disposed to each other so that both cores are magnetically coupled to each other.

The exciting coil 20 is formed in a rectangular shape whose dimension in a widthwise direction (“X”-axis direction) of the object arrangement space 40 is larger than the dimension in the “Y”-axis direction. The dimension in the “X”-axis direction of the exciting coil 20 is slightly larger than the dimension in the widthwise direction (“X”-axis direction) of the object arrangement space 40. Further, the detection coil 30 is formed in a rectangular shape whose dimension in the “X”-axis direction is substantially equal to a dimension in the “Y”-axis direction. A dimension in the “Y”-axis direction of the detection coil 30 is substantially equal to a dimension in the “Y”-axis direction of the exciting coil 20 and a dimension in the “X”-axis direction of the detection coil 30 is considerably smaller than a dimension in the “X”-axis direction of the exciting coil 20. In this embodiment, a length dimension when ten detection coils 30 are arranged in the “X”-axis direction is the same as that of the object arrangement space 40. In other words, the object arrangement space 40 is determined by a region in which the detection coils 30 are arranged.

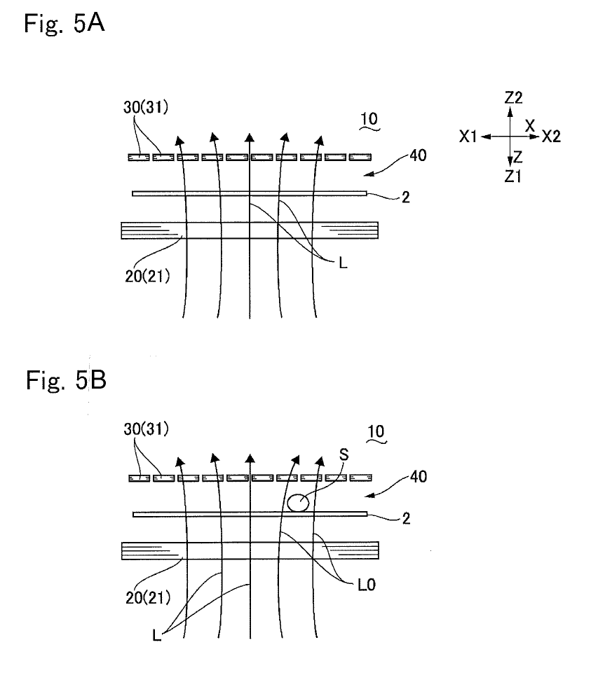

FIGS. 5A and 5B are explanatory views showing a measurement principle in the magnetic sensor element 12. FIG. 5A is an explanatory view showing a state that a metal foreign matter is not existed and FIG. 5B is an explanatory view showing a state that a metal foreign matter is existed. As shown in FIG. 5A, in the magnetic sensor device 10, when an alternating current is supplied to the exciting coil 20 by a drive circuit (not shown), the detection coils 30 detect a magnetic field generated by the exciting coil 20. In this case, when a metal foreign matter “S” is not mixed with a bank bill 2, as shown in FIG. 5A, the magnetic lines “L” draw lines such that directions of their tangent lines are coincided with directions of a magnetic field by the exciting coil 20. On the other hand, when a metal foreign matter “S” is mixed with a bank bill 2 as shown in FIG. 5B, although lines are drawn such that directions of tangent lines of the magnetic lines “L” are coincided with the directions of a magnetic field generated by the exciting coil 20 at positions apart from the metal foreign matter “S”, the magnetic lines “L0” are warped at positions near to the metal foreign matter “S” to draw lines which are not coincided with the direction of the magnetic field by the exciting coil 20. Therefore, a detected result is varied in the detection coils 30 located in the vicinity of the metal foreign matter “S” among a plurality of the detection coils 30. For example, in a case that a metal foreign matter “S” is made of magnetic material, magnetic permeability is increased and thus an output level from a detection coil 30 located in the vicinity of the metal foreign matter “S” among a plurality of the detection coils 30 is increased. On the other hand, for example, in a case that a metal foreign matter “S” is made of nonmagnetic material, an output level from the detection coil 30 located in the vicinity of the metal foreign matter “S” is lowered due to an eddy current. Therefore, an inspection circuit (not shown) for the magnetic sensor device 10 is capable of detecting a metal foreign matter “S” which is mixed with a bank bill 2.

In the ATM machine 1 shown in FIG. 1, when the magnetic sensor device 10 detects that a metal foreign matter “S” is not mixed with a bank bill 2, the belt type conveying mechanism 5 conveys the bank bill 2 having been inputted to a bank bill identification part provided in a subsequent stage. On the other hand, in a case that the magnetic sensor device 10 detects that a metal foreign matter “S” is mixed with a bank bill 2, the belt type conveying mechanism 5 does not convey the bank bill 2 having been inputted to the bank bill identification part provided in a subsequent stage but the belt type conveying mechanism 4 returns the bank bill 2 having been inputted to the input port 3. Therefore, a metal foreign matter “S” such as a clip is not conveyed to the bank bill identification part and thus the bank bill identification part does not occur a trouble caused by a metal foreign matter

### (Sensor Case)

As shown in FIGS. 2A and 2B and FIG. 3, the sensor case 11 includes a case member (hereinafter, referred to as an outside case 17) in a substantially rectangular parallelepiped shape slightly larger than the resin block body 15 in which the magnetic sensor element 12 is sealed, and a magnetic shield part 18 which is disposed on an inner side surface of the outside case 17. The outside case 17 is formed of nonmagnetic conductive metal such as aluminum. Instead of aluminum, material such as zinc, brass, SUS may be used. On the other hand, the magnetic shield part 18 is formed of magnetic metal such as Permalloy, Si steel plate, and SPCC. It is desirable that a plate thickness of the magnetic metal material structuring the magnetic shield part 18 is thick from a viewpoint for enhancing a shielding effect.

The outside case 17 is a housing in a rectangular parallelepiped shape and is provided with a lower case 51 and an upper case 52. The lower case 51 is provided with a bottom face 53 structuring a face on one end side “Y2” in the “Y”-axis direction, side faces 54 and 55 (third and fourth side faces) structuring faces on one side “X1” and the other side “X2” in the “X”-axis direction, and side faces 56 and 57 (first and second side faces) structuring faces on one side “Z1” and the other side “Z2” in the “Z”-axis direction. The side face 56 is disposed on a side opposite to the detection coils 30 with respect to the exciting coil 20 and the side face 57 is disposed on a side opposite to the exciting coil 20 with respect to the detection coils 30. Further, the side face 54 connects side edges on one end side “X1” in the “X”-axis direction of the side faces 56 and 57 and the side face 55 connects side edges on the other end side “X2” in the “X”-axis direction of the side faces 56 and 57. The side faces 54 through 57 structure a side face part of the outside case 17 (case side face part) and the bottom face 53 closes a lower end opening of the case side face part.

A face of the lower case 51 on an opposite side “Y2” to the bottom face 53 in the “Y”-axis direction is formed to be an opening. Further, an upper case 52 is formed in a rectangular plate shape and is attached to close the opening of the lower case 51 (upper end opening of the case side face part). The upper case 52 after having been attached forms an upper face of the outside case 17 and covers an upper side of the exciting coil 20 and the detection coils 30 (one side “Y2” in the “Y”-axis direction). On the other hand, a lower side of the exciting coil 20 and the detection coils 30 (the other side “Y1” in the “Y”-axis direction) is covered by the bottom face 53 of the lower case 51. The side faces 54 through 57 cover the exciting coil 20 and the detection coils 30 from both sides “X1” and “X2” in the “X”-axis direction and from both sides “Z1” and “Z2” in the “Z”-axis direction. The lower case 51 and the upper case 52 are formed with an opening 52a and an opening 53a at positions overlapped with the object arrangement space 40 in the “Y”-axis direction.

A magnetic flux passage part 19A is disposed in the outside case 17 at a position on one side “X1” in a widthwise direction (“X”-axis direction) of the object arrangement space 40. Further, a magnetic flux passage part 19B is disposed at a position on the other side “X2”. The magnetic flux passage parts 19A and 19B are provided in regions deviated in the “X”-axis direction from the object arrangement space 40, in other words, at positions deviated to sides from a region where the detection coils 30 and the exciting coil 20 are faced each other (on one side “X1” and the other side “X2” in the “X”-axis direction perpendicular to the “Z”-axis direction in which the both coils are faced each other). The magnetic flux passage parts 19A and 19B are attached to the bottom face 53 of the lower case 51. The magnetic flux passage parts 19A and 19B are, similarly to the outside case 17, formed of nonmagnetic conductive metal such as aluminum. Therefore, the magnetic flux passage parts 19A and 19B may be integrally formed with the lower case 51. The magnetic flux passage parts 19A and 19B are used as an attaching member for attaching the resin block body 15 to the outside case 17.

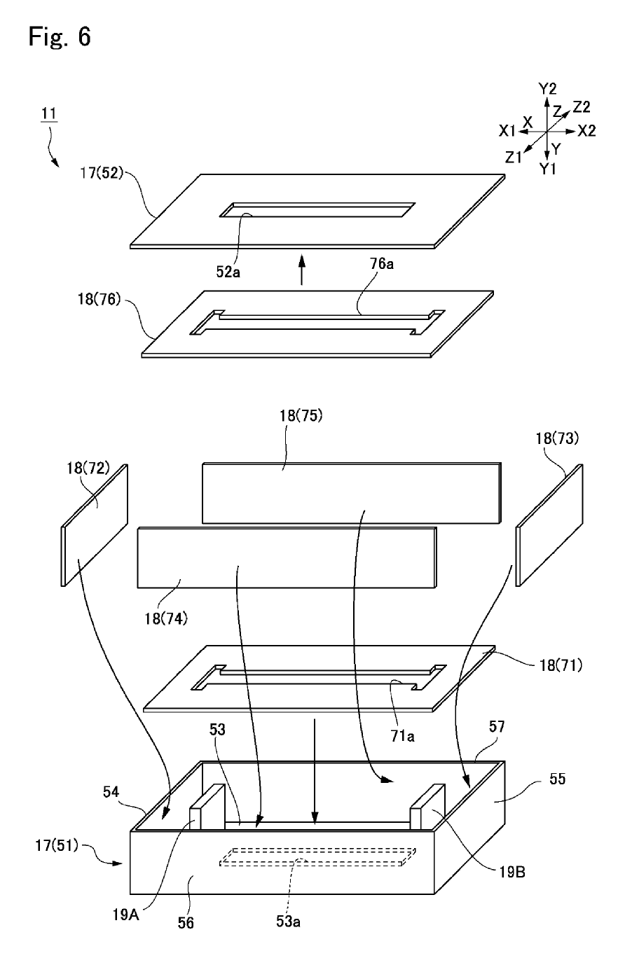

FIG. 6 is an exploded perspective view showing the sensor case 11. The magnetic shield part 18 includes a bottom part shield member 71, which is stuck on an inner face of the bottom face 53 of the lower case 51, and side face part shield members 72, 73, 74 and 75 which are stuck on inner side faces of the side faces 54, 55, 56 and 57 of the lower case 51. Further, the magnetic shield part 18 includes a cover part shield member 76 which is stuck on an inner side face of the upper case 52. The bottom part shield member 71 and the cover part shield member 76 are provided with openings 71a and 76a in regions corresponding to the object arrangement space 40 and the magnetic flux passage parts 19A and 19B located on the both sides of the object arrangement space 40.

### (Assembly Process of Magnetic Sensor Device)

Assembling work of the magnetic sensor device 10 is performed in order of the following (1) through (4).

(1) The magnetic sensor element 12 is disposed within the recessed part 14c and the inner side recessed part 14d of the resin frame 14a and is positioned. In this case, the frame parts 61, 62, 63 and 64 of the core body 60 are abutted with the bottom face of the recessed part 14c. After having been positioned, resin is filled in the recessed part 14c and the inner side recessed part 14d so that all the portions except terminal pins 12a of the magnetic sensor element 12 are covered with the resin and is solidified. In this manner, the resin block body 15 is structured.

(2) Next, the circuit board 13 is disposed on the surface of the resin filled part 14b and connecting work of the terminal pins 12a with the circuit board 13 is performed.

(3) Next, the bottom part shield member 71 and the side face part shield members 72, 73, 74 and 75 are stuck on the inner side faces of the lower case 51 and the resin block body 15 and the circuit board 13 are mounted on their inner sides. In this case, the magnetic flux passage parts 19A and 19B which are protruded from the bottom face 53 of the lower case 51 are fitted to the first and the second attaching parts 16A and 16B and the resin block body 15 is fixed. Then, connecting work of the circuit board 13 with wiring lines or connector terminals (not shown) for external connection is performed.

(4) Finally, the upper case 52 on which the cover part shield member 76 is stuck is attached so as to close the opening of the lower case 51.

When the above-mentioned processes (1) through (4) are performed, the magnetic sensor device 10 is structured in which a surrounding area for the magnetic sensor element 12 is completely covered by the outside case 17 and the magnetic shield part 18 except a portion facing the object arrangement space 40. In the completed magnetic sensor device 10, as shown in FIG. 2(B), a distance “L1” between the core body 60 and the bottom face 53 of the lower case 51 and a distance “L2” between the core body 60 and the upper case 52 are equal to each other.

### Principal Effects in this Embodiment

As described above, in the magnetic sensor device 10 in this embodiment, the detection coils 30 and the exciting coil 20 are faced each other with the object arrangement space 40 interposed therebetween, and the outside case 17 (lower case 51 and upper case 52) is disposed so as to cover the entire surrounding space for the coils except the sides directing to the object arrangement space 40 from the respective coils. Specifically, one side “Y1” in the “Y”-axis direction of the detection coils 30 and the exciting coil 20 is covered by the bottom face 53 of the lower case 51 and the other side “Y1” is covered by the upper case 52. Further, one side “X1” in the “X”-axis direction of the detection coils 30 and the exciting coil 20 is covered by the side face 54 of the lower case 51 and the other side “X2” is covered by the side face 55 of the lower case 51. In addition, one side “Z1” in the “Z”-axis direction of the exciting coil 20 is covered by the side face 56 of the lower case 51, and the other side “Z2” in the “Z”-axis direction of the detection coils 30 is covered by the side face 57 of the lower case 51. According to this structure, an eddy current is generated in the nonmagnetic conductive metal (aluminum in this embodiment) which forms the outside case 17 and a magnetic field opposite to the magnetic field by the detection coils 30 and the exciting coil 20 is generated. As a result, the original magnetic field is canceled and thus extension of the magnetic field by the detection coils 30 and the exciting coil 20 to the outside can be prevented without affecting the magnetic field in the object arrangement space 40. Therefore, erroneous detection caused by an electric conductor (electric conductor other than an inspection object) located on the outside of the object arrangement space 40 can be prevented. Further, extension of the magnetic field to a region apart from the object arrangement space 40 is prevented and thus detection resolution is improved.

Further, in this embodiment, the magnetic shield part 18 made of a magnetic member (Permalloy in this embodiment) is stuck on the inner side face of the outside case 17. Specifically, the magnetic shield part 18 includes the side face part shield members 72, 73, 74 and 75, which are stuck on the inner side faces of the side faces 56 and 57 (first and second side faces) structuring the faces on one side “Z1” and other side “Z2” in the “Z”-axis direction of the lower case 51 of the outside case 17 and the side faces 54 and 55 (third and fourth side faces) structuring the faces on one side “X1” and the other side “X2” in the “X”-axis direction, the bottom face shield member 71 which is stuck on the inner side face of the bottom face 53 structuring the face on one end side “Y1” in the “Y”-axis direction of the lower case 51, and the cover part shield member 76 which is stuck on the inner side face of the upper case 52 forming the upper face of the outside case 17. Further, the bottom face shield member 71 and the cover part shield member 76 are provided with the openings 71a and 76a in regions corresponding to the object arrangement space 40 and the magnetic flux passage parts 19A and 19B disposed on its both sides. Since a magnetic member is easy to make the magnetism pass, when a disturbance magnetic field is present, the disturbance magnetic field passes through the magnetic member structuring the magnetic shield part 18. Therefore, the inside space covered by the magnetic shield part 18 can be prevented from being affected by the disturbance magnetic field. Accordingly, erroneous detection due to a disturbance magnetic field can be prevented. Further, the magnetic shield part 18 effectively functions as an electromagnetic noise countermeasure component (EMC) which is capable of preventing malfunction and erroneous detection due to electromagnetic noise from the outside.

In addition, in this embodiment, the magnetic sensor element 12 provided with the detection coils 30, the exciting coil 20 and the core body 60 is sealed by the resin sealing part 14 (resin frame 14a and resin filled part 14b) and thus trouble due to humidity, vibration or the like can be reduced. Therefore, reliability and durability of the magnetic sensor device 10 can be improved.

Further, in this embodiment, the resin block body 15 which seals the magnetic sensor element 12 is attached to the outside case 17 through the magnetic flux passage parts 19A and 19B. The magnetic flux passage parts 19A and 19B are, similarly to the outside case 17, made of nonmagnetic conductive metal and are disposed on one side “X1” and the other side “X2” in a widthwise direction (“X”-axis direction) of the object arrangement space 40. According to this structure, leakage flux directing from the exciting coil 20 and the detection coils 30 to the outside of the object arrangement space 40 is guided so as to pass through the magnetic flux passage parts 19A and 19B. Therefore, leakage of magnetic flux passing through the object arrangement space 40 to the outside can be reduced. Accordingly, the sensor sensitivity can be enhanced. Further, one structural member is used for both of an attaching member for attaching the resin block body 15 and a member for passing the magnetic flux and thus the number of structural members can be reduced. Required dimensions (thickness in the “X”-axis direction) of the magnetic flux passage parts 19A and 19B may be determined based on a drive frequency of the exciting coil 20. For example, it is desirable that the dimension is 0.1 mm or more when the drive frequency of the exciting coil 20 is 1 MHz, and the dimension is 2 mm or more when the drive frequency is 5 KHz. When the dimension is set as described above, the leakage flux can be guided to the magnetic flux passage parts 19A and 19B.

Further, in this embodiment, the distance “L1” between the core body 60 and the bottom face 53 of the lower case 51 and the distance “L2” between the core body 60 and the upper case 52 are equal to each other. In other words, the distance “L1” between the core body 60 and the bottom face 53 which is a portion of the outside case 17 disposed on its front face side and the distance “L2” between the core body 60 and the upper case 52 which is a portion of the outside case 17 disposed on its rear face side are equal to each other, and the sensor case 11 is structured so as to be symmetric with respect to the detection coils 30 and the exciting coils 20. According to this structure, a magnetic field on the bottom face 53 side and a magnetic field on the upper case 52 side can be made to be symmetric. Therefore, sensitivity for a bank bill 2 passing through the object arrangement space 40 can be enhanced.

Further, in this embodiment, the exciting coil 20 is provided around the exciting coil core 66 disposed on one side “Z1” in the “Z”-axis direction with respect to the object arrangement space 40 and the detection coils 30 are provided around the detection coil cores 65 disposed on the other side “Z2” in the “Z”-axis direction with respect to the object arrangement space 40 and the exciting coil core 66 and the detection coil cores 65 are magnetically coupled to each other. Therefore, leakage flux can be reduced. Accordingly, high sensitivity can be obtained and leakage flux is hard to affect adjacent detection coils 30 and thus the resolution is high.

Further, in this embodiment, the exciting coil core 66 is a salient pole-shaped core, which is protruded from one side “Z1” in the “Z”-axis direction with respect to the object arrangement space 40 toward the other side “Z2” in the “Z”-axis direction with respect to the object arrangement space 40, and the detection coil core 65 is a salient pole-shaped core which is protruded from the other side “Z2” in the “Z”-axis direction with respect to the object arrangement space 40 toward the one side “Z1” in the “Z”-axis direction with respect to the object arrangement space 40. Further, a plurality of the detection coil cores 65 is disposed on the other side “Z2” in the “Z”-axis direction with respect to the object arrangement space 40 and the detection coil 30 is provided around each of a plurality of the detection coil cores 65. Further, one exciting coil core 66 is disposed on the one side “Z1” in the “Z”-axis direction with respect to the object arrangement space 40. According to this structure, the exciting coil 20 and the detection coils 30 are wound around a salient pole-shaped core and thus leakage flux can be reduced and high sensitivity can be obtained. Further, leakage flux is hard to affect adjacent detection coils and thus the resolution is high.

### Modified Embodiments

(1) In the embodiment described above, the magnetic shield part 18 made of a magnetic member (Permalloy in this embodiment) is stuck on an inner side face of the outside case 17. However, the magnetic shield part 18 made of a magnetic member may be stuck on an outer side face of the outside case 17. Alternatively, a magnetic member may be stuck on both an inner side face and an outer side face of the outside case 17 to form the magnetic shield part 18 on both faces on the inner side and the outer side of the outside case 17. Further, the magnetic member structuring the magnetic shield part 18 and the outside case 17 may be contacted with each other as the embodiment described above and, alternatively, a space may be provided between the magnetic member and the outside case 17.

(2) In the embodiment described above, the magnetic flux passage parts 19A and 19B for reducing leakage flux to the outside are also used as an attaching member for fixing the resin block body 15 within the outside case 17. However, the resin block body 15 may be fixed within the outside case 17 by another method. For example, the resin block body 15 may be fixed to the bottom face of the outside case 17 by using a screw or the like. In this case, the magnetic flux passage parts 19A and 19B are not required to provide with a function as the attaching member described above and thus shapes, positions and dimensions of the magnetic flux passage parts 19A and 19B can be set freely. Further, in the embodiment described above, the magnetic flux passage parts 19A and 19B are provided on both sides with respect to the object arrangement space 40 but the magnetic flux passage part may be provided only on one side.

(3) In the embodiment described above, the outside case 17 made of nonmagnetic conductive metal is a housing formed in a rectangular parallelepiped shape and the outside case 17 is formed by assembling two members comprised of the lower case 51 structuring a bottom face and a side face of the housing and the upper case 52 structuring only an upper face of the housing. However, the shapes of the members for assembling the outside case 17 are not limited to these shapes. In other words, a bottom face, a side face, and an upper face of the housing may be formed of separate members and, alternatively, a plurality of faces may be appropriately unified with each other to form one member. Further, the shape of the outside case 17 itself is not limited to a rectangular parallelepiped shape and a shape may be adopted which is capable of covering the entire surrounding space of both the detection coils 30 and the exciting coil 20 except the sides toward the object arrangement space 40 from both the coils. For example, planar shapes of the bottom face and the upper face may be formed in an elliptic shape or a polygonal shape.

(4) In the embodiment described above, a magnetic member (bottom part shield member 71, side face part shield members 72, 73, 74 and 75, cover part shield member 76) which is separately formed from the outside case 17 is stuck on the inner side face of the outside case 17 to structure the magnetic shield part 18. However, it may be structured that the respective magnetic members structuring the magnetic shield part 18 and a nonmagnetic conductive metal plate structuring the respective faces of the outside case 17 are integrated with each other in advance as one component for use.

(5) In the embodiment described above, the core body 60 formed in a rectangular frame shape is used but a core body formed in another shape may be used. For example, a magnetic body structuring the exciting coil core 66 and a magnetic body structuring the detection coil core 65 are separately provided and these magnetic bodies are disposed close to each other to magnetically couple to each other. Alternatively, these magnetic bodies may be integrally formed into one magnetic body through another magnetic body.

(6) In the embodiment described above, the exciting coil 20 is disposed on one side “Z1” in the “Z”-axis direction with respect to the object arrangement space 40 and the detection coils 30 are disposed on the other side “Z2”. However, it may be structured that a first exciting coil and first detection coils are disposed on one side “Z1” in the “Z”-axis direction with respect to the object arrangement space 40 and a second exciting coil and second detection coils are disposed on the other side “Z2”. In this case, instead of using the exciting coil core 66 and the detection coil cores 65 as the embodiment described above, a core may be used having a shape in which its tip end is formed with salient poles around which detection coils are wound and an exciting coil is wound around a root portion of the salient poles. When two sets of detection coils and an exciting coil are provided as described above, even in a case that an inspection object is located in the object arrangement space 40 at any position with a distance from the exciting coil and the detection coils, detection can be performed at a substantially equal sensitivity.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A magnetic sensor device comprising:
an exciting coil;
a detection coil which faces the exciting coil and is structured to detect an AC magnetic field generated by the exciting coil;
an object arrangement space which is provided between the detection coil and the exciting coil; and
a case member which covers an entire surrounding area for the detection coil and the exciting coil except a side facing the exciting coil in a surrounding area for the detection coil and except a side facing the detection coil in a surrounding area for the exciting coil;
wherein the case member is made of nonmagnetic conductive metal.

2. The magnetic sensor device according to claim 1, further comprising a magnetic shield part comprised of a magnetic member which is disposed on one of an inner side and an outer side of the case member, or both of the inner side and the outer side of the case member.

3. The magnetic sensor device according to claim 2, wherein
the case member comprises:
a first side face which is disposed on a side opposite to the detection coil with respect to the exciting coil;
a second side face which is disposed on a side opposite to the exciting coil with respect to the detection coil;
a third side face which connects one side edge of the first side face with one side edge of the second side face;
a fourth side face which connects the other side edge of the first side face with the other side edge of the second side face;
an upper face which closes an upper end opening of a case side face part comprised of the first side face, the second side face, the third side face and the fourth side face and covers an upper side of the detection coil and the exciting coil; and
a bottom face which closes a lower end opening of the case side face part and covers a lower side of the detection coil and the exciting coil, and
the upper face and the bottom face are provided with openings formed in regions corresponding to the object arrangement space.

4. The magnetic sensor device according to claim 3, wherein
the magnetic shield part comprises:
a side face part shield member which is stuck on respective inner side faces of the first side face, the second side face, the third side face and the fourth side face;
a bottom face shield member which is stuck on an inner side face of the bottom face; and
a cover part shield member which is stuck on an inner side face of the upper face; and
the bottom face shield member and the cover part shield member are provided with openings formed in regions corresponding to the object arrangement space.

5. The magnetic sensor device according to claim 1, further comprising a magnetic flux passage part which is disposed at a position deviated from a region where the exciting coil and the detection coil are faced each other in a direction perpendicular to a direction that the exciting coil and the detection coil are faced each other,
wherein the magnetic flux passage part is made of nonmagnetic conductive metal.

6. The magnetic sensor device according to claim 5, wherein the magnetic flux passage part is disposed on both of one side in a widthwise direction of the object arrangement space and the other side in the widthwise direction of the object arrangement space.

7. The magnetic sensor device according to claim 5, wherein
the case member comprises:
a first side face which is disposed on a side opposite to the detection coil with respect to the exciting coil;
a second side face which is disposed on a side opposite to the exciting coil with respect to the detection coil;
a third side face which connects one side edge of the first side face with one side edge of the second side face;
a fourth side face which connects the other side edge of the first side face with the other side edge of the second side face;
an upper face which closes an upper end opening of a case side face part comprised of the first side face, the second side face, the third side face and the fourth side face and covers an upper side of the detection coil and the exciting coil; and
a bottom face which closes a lower end opening of the case side face part and covers a lower side of the detection coil and the exciting coil;
the upper face and the bottom face are provided with openings formed in regions corresponding to the object arrangement space; and
the magnetic flux passage part is attached to the bottom face of the case member and is formed so as to protrude toward the upper face of the case member from the bottom face.

8. The magnetic sensor device according to claim 5, further comprising:
an exciting coil core to which the exciting coil is attached;
a detection coil core to which the detection coil is attached; and
a resin sealing part which seals a magnetic sensor element structured so that the exciting coil is attached to the exciting coil core and the detection coil is attached to the detection coil core;
wherein the resin sealing part forms a resin block body in which the magnetic sensor element is sealed, and
wherein the resin block body is attached to the case member through the magnetic flux passage part.

9. The magnetic sensor device according to claim 8, wherein the exciting coil core and the detection coil core are magnetically coupled to each other.

10. The magnetic sensor device according to claim 8, wherein
the exciting coil core and the detection coil core are provided in a core body formed in a frame shape which surrounds the object arrangement space,
the core body is formed in a plate shape, and
a distance between the core body and a portion of the case member disposed on a front face side of the core body and a distance between the core body and a portion of the case member disposed on a rear face side of the core body are equal to each other.

11. The magnetic sensor device according to claim 1, wherein
the exciting coil is provided around an exciting coil core disposed on one side with respect to the object arrangement space,
the detection coil is provided around a detection coil core disposed on the other side with respect to the object arrangement space, and
the exciting coil core and the detection coil core are magnetically coupled to each other.

12. The magnetic sensor device according to claim 11, wherein
a plurality of the detection coil cores is disposed on the other side with respect to the object arrangement space, and
the detection coil is provided around each of a plurality of the detection coil cores.

13. The magnetic sensor device according to claim 11, wherein one piece of the exciting coil core is disposed on one side with respect to the object arrangement space.

14. The magnetic sensor device according to claim 11, wherein
the exciting coil core is a salient pole-shaped core which is protruded from one side with respect to the object arrangement space toward the other side with respect to the object arrangement space, and
the detection coil core is a plurality of salient pole-shaped cores which are formed of one piece of core body and is protruded from the other side with respect to the object arrangement space toward the one side with respect to the object arrangement space.

15. The magnetic sensor device according to claim 1, further comprising a conveying mechanism which conveys an inspection object to the object arrangement space.

16. The magnetic sensor device according to claim 11, wherein
the case member comprises:
a first side face which is disposed on a side opposite to the detection coil with respect to the exciting coil;
a second side face which is disposed on a side opposite to the exciting coil with respect to the detection coil;
a third side face which connects one side edge of the first side face with one side edge of the second side face;
a fourth side face which connects the other side edge of the first side face with the other side edge of the second side face;
an upper face which closes an upper end opening of a case side face part comprised of the first side face, the second side face, the third side face and the fourth side face and covers an upper side of the detection coil and the exciting coil; and
a bottom face which closes a lower end opening of the case side face part and covers a lower side of the detection coil and the exciting coil;
the upper face and the bottom face are provided with openings formed in regions corresponding to the object arrangement space; and
a magnetic shield part comprised of a magnetic member is disposed on one of an inner side and an outer side of the case member, or both of the inner side and the outer side of the case member.

17. The magnetic sensor device according to claim 16, further comprising a magnetic flux passage part which is disposed at a position deviated from a region where the exciting coil and the detection coil are faced each other in a direction perpendicular to a direction that the exciting coil and the detection coil are faced each other,
wherein the magnetic flux passage part is made of nonmagnetic conductive metal.

18. The magnetic sensor device according to claim 17, wherein the magnetic flux passage part is attached to the bottom face of the case member and is formed so as to protrude toward the upper face of the case member from the bottom face.

19. The magnetic sensor device according to claim 12, further comprising
a resin sealing part which seals a magnetic sensor element that is structured so that the exciting coil is attached to the exciting coil core and the detection coil is attached to each of a plurality of the detection coil cores,
wherein the resin sealing part forms a resin block body in which the magnetic sensor element is sealed, and
wherein the resin block body is structured of a resin frame which is molded in advance and is disposed in an inside of the case member, and a resin filled part which is filled so that the magnetic sensor element disposed on the resin frame is covered.

20. The magnetic sensor device according to claim 19, wherein
the resin frame is formed with a recessed part which corresponds to an outward form of the magnetic sensor element and on which the magnetic sensor element is disposed,
an inner side recessed part which is recessed with respect to the recessed part is formed in an inner periphery part of the recessed part, and
the resin filled part is formed by filling resin in the recessed part and the inner side recessed part.
